(19) United States
(12) Patent Application Publication
(10) Pub. No.: US 2007/0064525 A1
(43) Pub. Date: Mar. 22, 2007

(54) Marine transponder

(75) Inventors: Phillip David Sanders, Beeston (GB); Gordon Paul Smith, Wollaton (GB)

Correspondence Address: FOLEY AND LARDNER LLP;SUITE 500, 3000 K STREET NW, WASHINGTON, DC, 20007, US

(73) Assignee: PAAAG LTD.

(21) Appl. No.: 11/302,513

(22) Filed: Dec. 14, 2005

(30) Foreign Application Priority Data
Sep. 22, 2005 (GB) 0519326.3

(51) Int. Cl. H04B 1/59

(52) U.S. Cl. 367/4

(57) ABSTRACT

The invention provides a marine transponder 100 comprising a position module 102, a satellite uplink module 104 and a microcontroller 106, the microcontroller being operable at intervals to activate the position module 102 for providing a location reading and to activate the satellite uplink module 104 for transmission of the location reading and an identifying code.

The invention relates to a marine transponder and an associated system, method and website for use with the transponder.

According to the invention, there is provided a marine transponder comprising a position module, a satellite uplink module and a microcontroller, the microcontroller being operable at intervals to activate the position module for providing a location reading and to activate the satellite uplink module for transmission of the location reading and an identifying code.

The position module of the transponder may use the GPS system or any other similar or equivalent positioning system (for example the Galileo system) optionally linked with any network of land-based stations for accuracy enhancement.

The marine transponder may include a biodegradable housing. The transponder is designed to run for a considerable period of time in a hostile marine environment, before the biodegradable plastic of which the bottle is made degrades, and the bottle decays safely into the water.

The marine transponder may include a rocker for generating electric charge for storage in charge storage means. The rocker uses the motion imparted by the swell of the sea to generate charge, such that the transponder is self-powered.

The rocker and the charge storage means may be mounted near a base of the transponder, in order to promote stability, to improve the efficiency of the power generation, and to allow for the antennae of the GPS module and satellite uplink module, which may be placed at the opposite end of the transponder to the rocker and charge storage means, to face upwardly.

In a preferred embodiment, the charge storage means is a capacitor. For environmental reasons, no batteries are used, as rechargeable storage cells can become contaminating when they break down, especially in saline conditions.

The charge storage means may supply power continuously to the microcontroller, allowing the continuous function of parts of the microcontroller such as a clock circuit.

The marine transponder may include a water sensor connected to the microcontroller. The provision of a water sensor allows for the transponder to be activated only when first cast into the water, thereby prolonging its life.

The water sensor may include at least one pair of electrodes mounted on the outside of the transponder.

The microcontroller may be operable to activate when the water sensor detects water surrounding the transponder. Water can be detected by the flow of a continuous current through the electrodes.

The microcontroller may be operable to set a permanent flag in non-volatile memory upon detection of water surrounding the transponder. This ensures that the transponder will remain activated from first contact with the water.

The microcontroller may include a low power clock circuit that runs continually and outputs a signal upon the lapse of a predetermined interval.

The microcontroller is operable to turn off during the predetermined interval, thus conserving power.

The marine transponder may include a voltage sensor connected between the charge storage means and the microcontroller. The provision of a voltage sensor allows for information on the state of the charge storage means to be used by the microcontroller.

The microcontroller may be operable to wake up upon detection of a voltage at a first predetermined level by the voltage sensor. This allows the transponder to continue functioning following a power outage.

The first predetermined level may represent sufficient power to obtain a reading by the GPS module and then transmit the reading by the satellite uplink module.

Alternatively, the first predetermined level may represent sufficient power to obtain a reading by the GPS module but not to transmit the reading by the satellite uplink module. This arrangement provides for time between the GPS reading being obtained and being transmitted for the transponder to recharge.

The voltage sensor may be connected to a comparator input of the microcontroller. By attaching the voltage sensor to 8 comparator input in the microcontroller and setting a trigger level internally, a wake up interrupt can be generated that brings the microcontroller on line when the stored voltage reaches that level.

The voltage sensor may be connected to an analogue-to-digital converter input of the microcontroller.

The microcontroller may be operable to monitor the output of the voltage sensor.

The microcontroller may be operable to store in non-volatile memory the reading obtained from the GPS module. Thus, the reading can be stored pending transmission following a power outage.

The microcontroller may be operable to delay transmission of the reading by the satellite uplink module until the voltage sensor detects a voltage at a second predetermined level. Thus, the transponder is able to wait until sufficient power is acquired before using the power-hungry satellite uplink module.

The microcontroller may be operable to obtain a time fix from the GPS module following a power outage. A significant power outage may result in time information being lost.

The microcontroller may be operable to activate the GPS module to obtain the time fix upon detection of a voltage at a third predetermined level by the voltage sensor. The time fix requires more power than obtaining a normal reading. The provision of a third predetermined level accounts for this.

The microcontroller may be operable to transmit by the satellite uplink module a time and/or date of the reading obtained by the GPS module.

The microcontroller may be operable to store in non-volatile memory a plurality of readings obtained by the GPS module and the time and/or date of each reading. This feature is useful when there is consistently insufficient power available to operate the satellite uplink module.

The microcontroller may be operable to transmit separately by the satellite uplink module each reading and its associated time and date.

The microcontroller may be operable, once the non-volatile memory is fill, to replace old readings with new readings.

The microcontroller may be operable to format the reading obtained from the GPS module into a Short Message Service-type message for transmission by the satellite uplink module.

The microcontroller may be operable to reduce the predetermined interval if the voltage detected by the voltage sensor is consistently below a fourth predetermined level.

The microcontroller may be operable to increase the predetermined interval if the voltage detected by the voltage sensor is consistently above a fifth predetermined level.

In this way, the transponder is able to respond to variations in the amount of power that is available.

The microcontroller may be operable to turn off the satellite uplink module while the GPS module is activated, and to turn off the GPS module while the satellite uplink module is activated.

Thus, if the power fails to get to the level where a complete cycle of a GPS fix followed by a communications session is possible, the microcontroller stops trying to execute both operations at the same time and runs them as two separate cycles with a delay between them to allow the power to grow, the GPS fix information being saved in the microcontroller between the two cycles.

The marine transponder may include a power switch connected to the microcontroller whereby the microcontroller activates one or the other of the GPS module and satellite uplink module.

The unique identifying code may be a phone number.

According to the invention, there is also provided a system for tracking a marine transponder, the system comprising a communications server for interfacing with a ground station of a satellite communications system and with a communications network, the communications server including means for receiving an identifying code and a location reading from the ground station, the code and location reading having been transmitted by the marine transponder, and means for transmitting the code and location reading to an end user over the communications network.

The system may include a local server for interfacing with a telephone network and/or the internet, the local server including means to receive the unique identifying code from the communications server via the communications network, and means to transmit the code to the end user via the communications network.

The communications network may include the telephone network and/or the internet.

The unique identifying code may be part of a message containing information related to a date and/or time.

The message may be a Short Message Service-type message.

The present invention also provides a method of tracking a marine transponder, the method comprising receiving an identifying code and a location reading from a satellite communications system and a communications network, the code and location reading having been transmitted by the marine transponder, and transmitting the code and location reading to an end user over the communications network.

According to the present invention, there is also provided a computer program product directly loadable into the internal memory of a digital computer, comprising software code portions for performing the method of the present invention when said product is run on a computer.

According to the present invention, there is also provided a computer program directly loadable into the internal memory of a digital computer, comprising software code portions for performing the method of the present invention when said program is run on a computer.

According to the present invention, there is also provided a carrier, which may comprise electronic signals, for a computer program embodying the present invention.

According to the present invention, there is also provided electronic distribution of a computer program product, or a computer program, or a carrier of the present invention.

According to the invention, there is also provided a website including means for receiving a plurality of identifying codes and associated location readings from a satellite ground station, the identifying codes and location readings having been transmitted to the satellite ground station by one or more marine transponders.

The invention may provide amusement for children who wish to throw a marine transponder into the sea and track its progress using the internet Additionally or alternatively, the invention may be used for academic or educational purposes.

The website may include means for plotting a location indicated by a location reading on a map.

The website may include means for plotting on the map locations indicated by a series of successive location readings received from a particular marine transponder.

The website may include means for plotting on the map locations indicated by two or more series of successive readings, each series having been received from respective marine transponders.

The website may include means for billing users according, to length of time registered with the website and/or number of accesses or hits to the website.

The present invention is particularly, but not solely, applicable to educational uses, and/or to promotional uses. The shape, structure, markings and/or colouring of the transponder and/or housing may be designed in accordance with a company to be promoted; thus for example the exterior of the transponder may be shaped to represent a container or bottle representative of the company being promoted.

In one application of the present invention, the transponder housing contains some cremated ashes of a deceased person or animal.

Embodiments of the invention also provide methods of handling, administering, managing, and processing transponder, system and methods information and financial data, including that associated with a website of the present invention, all as defined by the embodiments of the present invention as described herein.

In order that the invention may more readily be understood, a description is now given, by way of example only, reference being made to the accompanying drawings, in which:

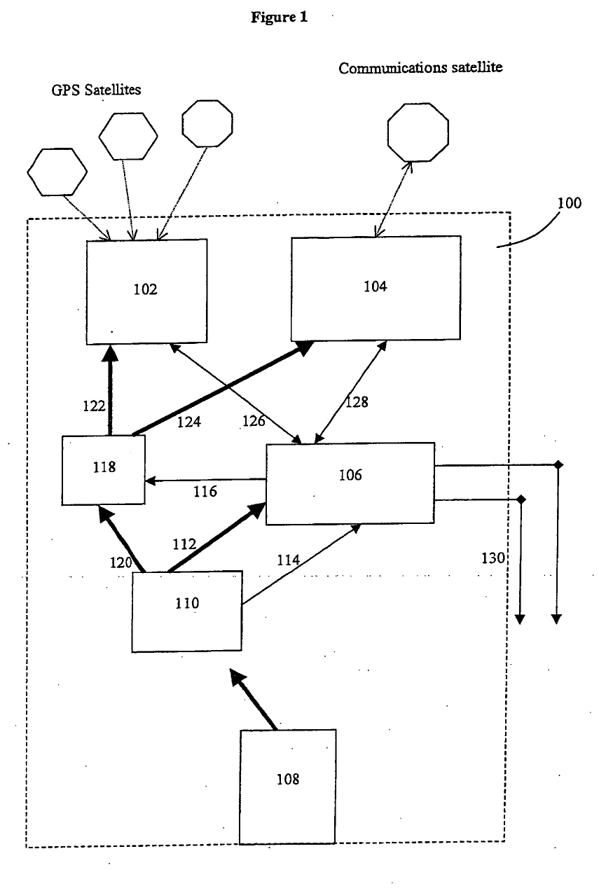

FIG. 1 is a schematic diagram of a bottle 100 according to the invention;

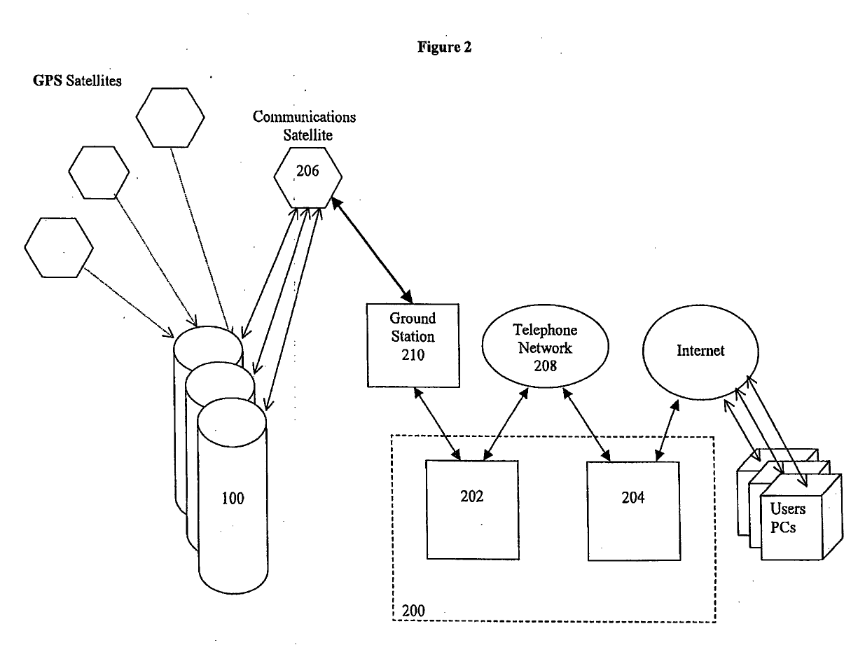

FIG. 2 is a schematic diagram of a system 200 according to the invention.

The bottle 100 shown in FIG. 1 includes a GPS module (including a receiver and processor) 102, and a satellite telephone uplink module 104. The GPS module 102 and the satellite uplink module 104 are separate modules each with its own antenna, mounted near the top of the bottle 100 where, in use, they are held above the surface of the water.

Each bottle 100 determines its position via the GPS module 102 and transmits this position as well as an identifying code to a server via the satellite uplink module 104.

The GPS satellite system consists of a set of satellites in low earth orbit controlled from the USA. Each satellite contains a very accurate clock, and continually transmits clock and positional information towards the surface of the earth. The GPS module 102 of bottle 100 collects a set of such transmissions from up to 12 different satellites and combines the received information along with its own internal clock to determine the location of bottle 100 on the surface of the earth. There are two levels of accuracy available from the GPS system. The less accurate civilian system gives an error of a few metres, which is precise enough for this application. The most accurate system is only available for military applications.

Accuracy of the civilian system can be enhanced by linking with e.g. a network of land-based stations or other additional stations.

The bottle 100 includes a low power microcontroller 106, which controls all of the electronic systems within the bottle 100. The microcontroller 106 consumes very little power in full operation and is capable of turning itself off completely, or turning off presently—unused parts of its own internal circuitry, to minimise power consumption. The microcontroller 106 is set to remain turned off most of the time, and to wake up in certain circumstances, for example after a specified amount of time, or when power reaches a given level.

The bottle 100 includes a rocker 108 and a storage capacitor 110. Power for all of the systems inside the bottle 100 is generated by the motion of the bottle 100. As it rocks in the swell, the rocker 108, an electromagnetic device, generates power. This energy is rectified and saved within the capacitor 10, which acts as a storage device. For environmental reasons, no batteries are used, as rechargeable storage cells can become poisonous when they break down, especially in saline conditions. The rocker 108 and the capacitor 110 are mounted near the base of the bottle 100 in order to promote stability, since these components are amongst the heavier items and do not need access to the sky, and because the further from the centre of gravity, the more efficient the rocker power generation will be. Depending upon the shape of the bottle 100 and the relative weights of the different modules, extra ballast or buoyancy may be required, for example given the environmental considerations, the ballast is sand, bound together with some biodegradable polymer, which dissolves on contact with any water leaking in.

The energy available from the swell is variable, from almost nothing when the bottle 100 is becalmed, to large amounts in storm conditions. The result is that when the sky is clear and the satellites accessible, there may be insufficient power for the signal transmitted by the satellite telephone uplink 104 to reach them, but when there is a surfeit of power, meteorological conditions may make the satellites inaccessible. For these reasons, the control of power is crucial to the efficient and effective operation of the bottle 100.

The storage capacitor 110 is efficient in order to minimise power loss. A small amount of power is supplied continuously to the microcontroller 106 via a connection 112. As long as there is a small level of charge in the capacitor 110, the microcontroller 106 operates in low power mode. Under the severest of low power conditions, when the bottle 100 has been becalmed for a long time, the charge in the capacitor 110 may fall to a level where the microcontroller 106 shuts down completely. When meteorological conditions change and power levels rise, the microcontroller 106 wakes up and detects that it has been subject to a total power failure (a black-out), or a situation where the power fell below the minimum necessary to keep the microcontroller 106 running (a brown-out). The microcontroller 106 then waits until the energy stored has increased to a reasonable level before using that power to reinitialise the systems.

A sensor 114 is connected between the storage capacitor 110 and the microcontroller 106. The sensor 114 is connected to the microcontroller 106 in such a way that it will wake up the microcontroller 106 when the voltage reaches a certain level. By attaching the sensor 114 to a comparator input in the microcontroller 106 and setting the trigger level internally, a wake up interrupt is generated that brings the microcontroller 106 on line when the stored voltage reaches that level. In normal operation, this level is set at the point where there is sufficient power to obtain a position and then transmit that position. The sensor 114 is also connected into an analogue-to-digital converter input of the microcontroller 106, allowing the voltage to be monitored more precisely and the level of energy stored to be calculated at any time. The voltage across the capacitor is sensed via a potential divider, designed so that the voltage sensed at the microcontroller cannot exceed the maximum allowed by the device even when the capacitor reaches the maximum allowed charge. The microcontroller has a power-down mode, which can be interrupted by several different events. One of the events occurs when the voltage on the capacitor reaches a pre-programmed level. This level is set by the microcontroller after deciding how much power it will need for a particular operation.

The microcontroller 106 attempts a communication session at regular intervals set by its internal clock. The microcontroller 106 has a low power clock circuit that runs continually as long as minimal power is available, and wakes up the microcontroller 106 when the next communications cycle is due. After a severe power outage, a black-out or brown-out, the time information may be lost. When this happens, an accurate time fix is obtained from the GPS module 102. However this may take some time and require a full charge whilst the module receives the information from the GPS satellites. Hence, there may be a delay before the system can build up sufficient energy.

Since the microcontroller 106 is monitoring the power constantly, it can determine how quickly energy is restored to working levels after each communication session. In calm conditions, it is likely that the power available will be insufficient to keep up regular communications schedules. If the system attempts to keep to the schedule, the power will run out each ti me before completion of the complete communications session, and contact will be lost. To prevent this happening, the microcontroller 106 reduces the frequency of transmissions. When conditions improve and more power is available, the full schedule of transmissions is resumed.

To minimise the power requirements, the two most power-hungry components of the system, the GPS module 102 and the satellite uplink module 104, are powered down in normal operation. The microcontroller 106 turns them on one at a time only when required via a control signal 116. This signal 116 controls a power switch 118 so that the power flows from the capacitor 110 via a connection 120, through the switch 118, then either to the GPS module 102 via a connection 122, or to the satellite uplink module 104 via connection 124. In a variant, the GPS module 102 or satellite uplink module 104 may be turned on or off via control paths 126 and 128, such that a separate power switch is not required.

The microcontroller 106 takes into account the level of stored power available before attempting the satellite link. The power used is proportional to the length of time that the GPS module 102 and satellite uplink module 104 are active. The GPS module 102 can acquire the satellite data and get a fix in a few tens of seconds if it already knows approximately where it is and exactly what the time is (known as a warm state). However, if it is starting with no information (for example after a power black-out or brown-out) (known as a cold state), it can typically take 5 minutes and hence use much more power.

A GPS module works in several modes depending upon initial conditions. The first time it is used (a cold start), the module contains no initial data and hence has no idea of the time or of its position. It must therefore determine this information from the satellite transmissions; this can take a long time. Once this data is determined it is saved within the GPS module for the next attempt to obtain a fix.

The next time the GPS module is used (a warm start), the initial information within the module means that the fix can be made much more quickly. However this information may go out of date. The real time clock within the GPS satellites, is not as accurate or as stable as the atomic clocks usual to control the GPS satellites, and so the longer the time since the last GPS fix, the more out of synchronisation the clock becomes. Also as the Marine Transponder drifts in the currents, its positional information will become out of date. Both of these factors mean that in general: the longer between positional fixes; the longer each. particular fix takes.

Information on the state of the GPS module 102 is available to the microcontroller 106 via the control path 126. The microcontroller 106 takes account of this when deciding how much power is required.

Under some circumstances, the GPS fix will take longer than anticipated, and drain so much power that there is not enough for a transmission. When this happens, the position obtained from the GPS module 102 and the time at which it was obtained is saved in the microcontroller 106 until the power has built up to a level where the satellite uplink module 104 can be used to transfer the information.

The time taken to make the satellite uplink and transfer the positional information during a communications session is less easy to determine, as it depends upon several variables that are unknown to the satellite telephone uplink module 104. The microcontroller 106 copes with this by monitoring the performance of the satellite telephone uplink module 104 and adjusting its timing calculations accordingly. If the power runs out before a communications session is complete, not only is the positional information saved so that no GPS fix is required next time, but the system waits until a larger amount of power is available before attempting the communications session again

The positional fix from the GPS module 102 is formatted into an SMS type message compatible with the telephone system and transmitted via the satellite telephone uplink module 104 via the microcontroller 106. As well as the positional information, the time, date and a unique ID are also put into the message. The time and date identify when the positional fix was taken, and the ID uniquely identifies the bottle 100. Provision is also made for the situation where several positional fixes have been saved up in the microcontroller 106 because there has not been enough power to transmit them. When this happens, each fix with its time and date are sent as separate SMS messages. Once the satellite has acknowledged receipt of a message, the message is deleted from the microcontroller 106. If there is no receipt, the message is saved in order to retry later. This could lead to a build up of old data within the microcontroller 106, which has a limited non-volatile memory capacity. For this reason, once the save area is full, new information always replaces the oldest saved information.

Even with the best available storage devices and low power electronics, there is some small leakage of power, which increases with the inevitable degradation of systems in the hostile marine environment. As the systems degrade, the microcontroller 106 monitors the changes and modifies its internal working parameters accordingly so as to get the best possible performance. For example, if the power ceases to get to the level where a complete cycle of a GPS fix followed by a communications session becomes possible, the microcontroller 106 stops trying to execute both operations at the same time and runs them as two separate cycles with a delay between them to allow the power to grow, the GPS fix information being saved in the microcontroller 106 between the two cycles.

In general, the longer the bottle 100 stays at sea, the more its systems will degrade, and the less frequent will be the positional updates. One of the main responsibilities of the microcontroller 106 is to manage this run down and get the best possible performance from the bottle 100.

The bottle 100 includes a pair of electrodes 130 mounted on its outside and connected to the microcontroller 106. When first submerged, the microcontroller 106 is able to detect the current passing between the electrodes 130, even in impure fresh water, in order to determine that the bottle 100 is afloat To minimise any false triggering, the microcontroller 106 checks for a continuous current for some time before activating. The microcontroller 106 may have to wait until there is sufficient power available to accomplish this. Once activated, the microcontroller 106 sets a permanent flag in non-volatile memory so that the bottle 100 remains active even when the electrodes 130 no longer pass a current due to corrosion.

The bottle 100 has messages on its sides in several languages, asking the finder to throw it back into the water, or if too badly damaged, to report the discovery and the location.

The bottle 100 is made of a biodegradable plastic.

Elements of the exterior and interior of the bottle are designed wherever possible to maximise the major functions of the invention, especially the rocking motion of the transponder, in order to maximise the power stored and generated within the transponder. The above elements include the exterior shape of the transponder, the positioning of the interior elements and their relative weighting.

Also preferably the transponder is designed to ensure that that top of the structure tends to be held above the water level so that the antenna is exposed to the sky. Preferably the biodegradable plastic is transparent to the frequencies used in the microwave band.

In use, each bottle 100 is set afloat somewhere on the surface of the earth and will be carried by the currents in any direction.

FIG. 2 shows a tracking system 200 according to the invention. The system 200 includes a communications server 202 and a local server 204.

At regular intervals, each bottle 100 turns on its GPS module 102, determines its own position, and transmits this location via its satellite uplink module 104 to a communications satellite 206, from where the location is relayed into the telephone system 208 via the ground station 210. This information is sent in a message as if from a satellite phone, in a format such as the Short Message System (SMS). The satellite uplink module 104 need only maintain the connection long enough to pass the message via the satellite 206 to the communications server 202. The telephone network 208 forwards the message to its destination in good time.

The destination of the message is the communications server 202 handling information from all of the bottles 100. This information arrives in the form of message packets containing positional information as if from another phone. Each message comes from a particular bottle 100, which is identified by the phone number called from, as each bottle 100 is effectively a mobile satellite phone. There is identifying information in the message as well as the positional information and time information. The server 202 and/or 204 saves this information for each bottle 100 so that a log of the movement of the bottle 100 can be kept.

Users access the communications server 202 via the Internet. The server 202 and/or 204 holds a log of the position of each bottle 100. Having identified himself, each user can see a log of the position of his own bottle 100 and a map with a track representing the journey taken by the bottle 100. The maps are available in several scales to help with clarity. An option exists on the system for the user to register his bottle(s) 100 in a limited list with a group of others, or in a general list of everybody who has registered. When these lists are accessed, a map showing the tracks of all of the bottles 100 on the list can be examined at several scales, with the user's bottle 100 identified.

The present invention includes the provision of a website to provide updates, whether regular and/or upon specific requests, of tracking of the transponder of the registered client. Optionally, the registered client can be provided also with tracking information of one or more other associated transponders.

Thus, for example, each of a class of children can be given regular up-dates of progress of their transponder(s) together with equivalent information on those transponders of their class-mates. Thus, for example, each child has the information on his or her transponder shown in red, and the transponders of the class-mates in blue.

Preferably the website bills each registered client either on a regular (e.g. daily) charge basis, and/or on a charge each time the registered client accesses the website for an up-date.

Many parts of the world's oceans have circulating systems, which may cause the bottles 100 to stay in a small part of the ocean going around and around. The tracks of the bottles 100 will reflect this and show that the bottle 100 is still active despite appearing to stay in one place.

1. A marine transponder, comprising a position module, a satellite uplink module and a microcontroller, the microcontroller being operable at intervals to activate the position module for providing a location reading and to activate the satellite uplink module for transmission of the location reading and an identifying code.

2. The marine transponder of claim 1 including a rocker for generating electric charge for storage in charge storage means.

3. The marine transponder of claim 1 wherein the rocker and the charge storage means are mounted near a base of the transponder.

4. The marine transponder of claim 1 comprising a water sensor including at least one pair of electrodes mounted on the outside of the transponder.

5. The marine transponder of claim 1 wherein the microcontroller is operable to activate when the water sensor detects water surrounding the transponder.

6. The marine transponder of claim 1 wherein the microcontroller is operable to set a permanent flag in non-volatile memory upon detection of water around the transponder.

7. The marine transponder of claim 1 wherein the microcontroller includes a low power clock circuit that runs continually and outputs a signal upon the lapse of a predetermined interval.

8. The marine transponder of claim 1 wherein the microcontroller is operable to wake up upon detection of a voltage at a first predetermined level by the voltage sensor.

9. The marine transponder of claim 1 wherein the first predetermined level represents sufficient power to obtain a reading by the position module and then transmit the reading by the satellite uplink module.

10. The marine transponder of claim 1 wherein the first predetermined level represents sufficient power to obtain a reading by the position module but not to transmit the reading by the satellite uplink module.

11. The marine transponder of claim 1 wherein the microcontroller is operable to delay transmission of the reading by the satellite uplink module until the voltage sensor detects a voltage at a second predetermined level.

12. The marine transponder of claim 1 wherein the microcontroller is operable to obtain a time fix from the GPS module following a power outage.

13. The marine transponder of claim 1 wherein the microcontroller is operable to activate the position module to obtain the time fix upon detection of a voltage at a third predetermined level by the voltage sensor.

14. The marine transponder of claim 1 wherein the microcontroller is operable to reduce the predetermined interval if the voltage detected by the voltage sensor is consistently below a fourth predetermined level.

15. The marine transponder of claim 1 wherein the microcontroller is operable to increase the predetermined interval if the voltage detected by the voltage sensor is consistently above a fifth predetermined level.

16. The marine transponder of claim 1 wherein the microcontroller is operable to turn off the satellite uplink module while the position module is activated, and to turn off the position module while the satellite uplink module is activated.

17. The marine transponder of claim 1 including a power switch connected to the microcontroller whereby the microcontroller activates one or the other of the position module and satellite uplink module.

18. A system for tracking a marine transponder, the system comprising a communications server for interfacing with a ground station of a satellite communications system and with a communications network, the communications server including means for receiving an identifying code and a location reading from the ground station, the code and location reading having been transmitted by the marine transponder, and means for transmitting the code and location reading to an end user over the communications network.

19. The system of claim 18 including a local server for interfacing with a telephone network and/or the internet, the local server including means to receive the unique identifying code from the communications server via the communications network, and means to transmit the code to the end user via the communications network.

20. A method of tracking a marine transponder, the method comprising receiving an identifying code and a location reading from a satellite communications system and a communications network, the code and location reading having been transmitted by the marine transponder, and transmitting the code and location reading to an end user over the communications network.

21. A website including means for receiving a plurality of identifying codes and associated location readings from a satellite ground station, the identifying codes and location readings having been transmitted to the satellite ground station by one or more marine transponders.

22. The website of claim 21 including means for plotting a location indicated by a location reading on a map.
